(19) United States
(12) Patent Application Publication
(10) Pub. No.: US 2023/0026932 A1
(43) Pub. Date: Jan. 26, 2023

(54) CONTROL DEVICE, VEHICLE CONTROL SYSTEM, CONTROL METHOD AND STORAGE MEDIUM

(71) Applicant: TOYOTA JIDOSHA KABUSHIKI KAISHA, Aichi-ken (JP)

(72) Inventors: Masato ENDO, Nagoya-shi (JP); Yasuyuki KAMEZAKI, Toyota-shi (JP); Yasuhiro MURATA, Toyota-shi (JP); Takeo MORIAI, Nagakute-shi (JP); Kosuke SAKAKIBARA, Toyota-shi (JP); Kenta MIYAHARA, Okazaki-shi (JP); Takashi HAYASHI, Nagoya-shi (JP)

(21) Appl. No.: 17/751,563

(22) Filed: May 23, 2022

(30) Foreign Application Priority Data
Jul. 26, 2021 (JP) 2021-121745

(51) Int. Cl. B60W 40/09; B60W 50/14

(52) U.S. Cl. CPC B60W 40/09; B60W 50/14; B60W 2050/146

(57) ABSTRACT

In a center server as a control device, a processor is configured to acquire vehicle information on a vehicle, determine a driving skill of a driver from the acquired vehicle information, and notify the driver of permission information for permitting use of a function of the vehicle or application of equipment to the vehicle according to the determined driving skill.

### CROSS-REFERENCE TO RELATED APPLICATION

This application claims priority to Japanese Patent Application No. 2021-121745 filed on Jul. 26, 2021, incorporated herein by reference in its entirety.

### BACKGROUND

### 1. Technical Field

The present disclosure relates to a control device, a vehicle control system, a control method, and a storage medium for controlling a vehicle.

### 2. Description of Related Art

Japanese Unexamined Patent Application Publication No. 2012-117877 (JP 2012-117877 A) discloses a technique for ranking vehicles into a vehicle S of the highly advanced rank, a vehicle A of the advanced rank, a vehicle B of the intermediate rank, and a vehicle C of the beginner rank, which is a movement skill control device that enables information on movement skills of other vehicles to be acquired.

### SUMMARY

The technique described in JP 2012-117877 A only ranks drivers, and there is room for improvement in encouraging the ranked drivers to improve their driving skills.

An object of the present disclosure is to provide a control device, a vehicle control system, a control method, and a storage medium capable of encouraging a driver to improve the driving skill by permitting or restricting use of a function of a vehicle or application of equipment to the vehicle according to the driving skill of the driver.

A control device according to a first aspect of the present disclosure includes a processor. The processor is configured to acquire vehicle information on a vehicle, determine a driving skill of a driver from the acquired vehicle information, and notify the driver of permission information for permitting use of a function of the vehicle or application of equipment to the vehicle according to the determined driving skill.

In the control device of the first aspect, the processor determines the driving skill of the driver based on the vehicle information. Then, for example, when the determined driving skill is high, the control device permits the use of the function of the vehicle or the application of the equipment to the vehicle, and when the determined driving skill is low, the control device restricts the use of the function of the vehicle or the application of the equipment to the vehicle. Therefore, when the driver wishes to use the function of the vehicle or apply the equipment to the vehicle, the driver endeavors to improve the driving skill. That is, with the control device, it is possible to encourage the driver to improve the driving skill by permitting or restricting the use of the function of the vehicle or the application of the equipment to the vehicle according to the driving skill of the driver.

In the first aspect, the processor may provide an advice from a driver having a higher driving skill.

According to the control device having the above configuration, it is possible to encourage the driver to improve the driving skill by providing the advice from the driver having the higher driving skill to a driver determined to have the lower driving skill.

In the above aspect, the processor may determine the driving skill according to a model of the vehicle.

According to the control device having the above configuration, the driving skill can be determined by excluding the influence of a difference in a vehicle model.

In the above embodiment, a vehicle control system may include the control device of the first aspect, and the vehicle of which the use of the function or to which the application of the equipment according to the permission information is permitted.

According to the above configuration, it is possible to encourage the driver to improve the driving skill by permitting the use of the function of the vehicle or the application of the equipment to the vehicle according to the driving skill of the driver.

In the above configuration, the permission information may have a set deadline in the vehicle, and the vehicle may prohibit permission of the use of the function or the application of the equipment by the permission information of which the set deadline has expired.

According to the above configuration, when the time has passed after the reception of the determination of the driving skill, the reliability of the determination can be guaranteed by invalidating the permission of the use of the function of the vehicle or the application of the equipment to the vehicle.

In a control method according to a second aspect of the present disclosure, a computer executes processes including acquiring vehicle information on a vehicle, determining a driving skill of a driver from the acquired vehicle information, and notifying the driver of permission information for permitting use of a function of the vehicle or application of equipment to the vehicle according to the determined driving skill.

According to the above aspect, the computer determines the driving skill of the driver based on the vehicle information. Then, in the control method, for example, when the determined driving skill is high, the use of the function of the vehicle or the application of the equipment to the vehicle is permitted, and when the determined driving skill is low, the use of the function of the vehicle or the application of the equipment to the vehicle is restricted. Therefore, when the driver wishes to use the function of the vehicle or apply the equipment to the vehicle, the driver endeavors to improve the driving skill. That is, according to the control method, it is possible to encourage the driver to improve the driving skill by permitting or restricting the use of the function of the vehicle or the application of the equipment to the vehicle according to the driving skill of the driver.

A storage medium according to a third aspect of the present disclosure stores a program that causes a computer to execute acquiring vehicle information on a vehicle, determining a driving skill of a driver from the acquired vehicle information, and notifying the driver of permission information for permitting use of a function of the vehicle or application of equipment to the vehicle according to the determined driving skill.

The computer in which the program stored in the storage medium of the third aspect is executed is configured to determine the driving skill of the driver based on the vehicle information. Then, for example, when the determined driving skill is high, the computer permits the use of the function of the vehicle or the application of the equipment to the vehicle, and w % ben the determined driving skill is low, the control device restricts the use of the function of the vehicle or the application of the equipment to the vehicle. Therefore, when the driver wishes to use the function of the vehicle or apply the equipment to the vehicle, the driver endeavors to improve the driving skill. That is, according to the storage medium storing the program, it is possible to encourage the driver to improve the driving skill by permitting or restricting the use of the function of the vehicle or the application of the equipment to the vehicle according to the driving skill of the driver.

That is, according to the present embodiment, it is possible to encourage the driver to improve the driving skill by permitting or restricting the use of the function of the vehicle or the application of the equipment to the vehicle according to the driving skill of the driver.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing a schematic configuration of a vehicle control system according to an embodiment;

FIG. 2 is a block diagram showing a hardware configuration of a vehicle according to the embodiment;

FIG. 3 is a block diagram showing a functional configuration of an on-board unit according to the embodiment;

FIG. 4 is a block diagram showing a hardware configuration of a center server according to the embodiment:

FIG. 5 is a block diagram showing a functional configuration of the center server according to the embodiment:

FIG. 6 is a sequence diagram showing a flow of processing in the vehicle control system according to the embodiment;

FIG. 7 is a flowchart showing a flow of a determination process executed in the center server according to the embodiment; and

FIG. 8 is a flowchart showing a flow of a setting process executed in the on-board unit according to the embodiment.

### DETAILED DESCRIPTION OF EMBODIMENTS

A vehicle control system including a control device of the present disclosure will be described. The vehicle control system is a system that permits or restricts use of a function of a vehicle or application of equipment to the vehicle according to the driving skill of a driver of the vehicle.

Overall Structure

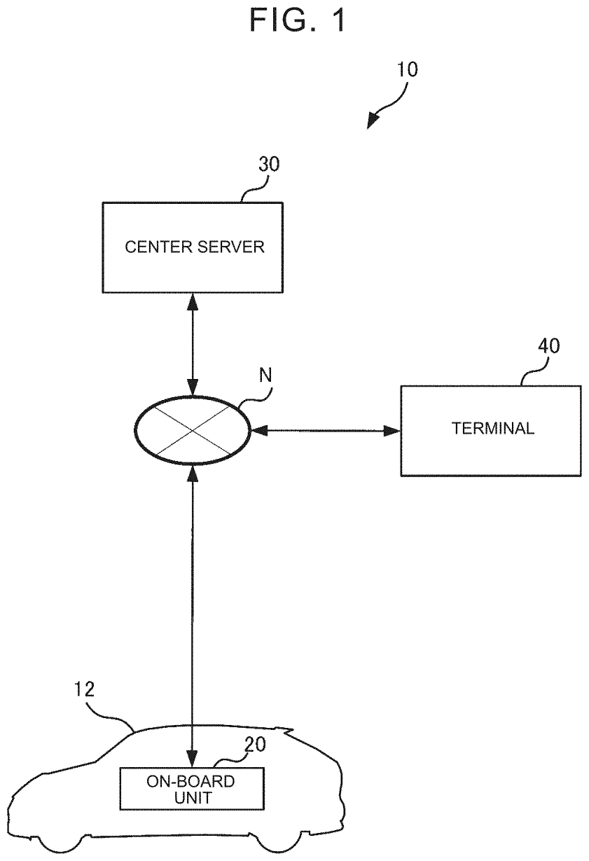

As shown in FIG. 1, a vehicle control system 10 according to an embodiment of the present disclosure includes a vehicle 12, a center server 30 as a control device, and a terminal 40. Further, the vehicle 12 is equipped with an on-board unit 20. The on-board unit 20, the center server 30, and the terminal 40 are connected to each other through a network N. Although FIG. 1 shows one vehicle 12, one on-board unit 20, and one terminal 40 with respect to one center server 30, but the numbers of the vehicles 12, the on-board units 20, and the terminals 40 are not limited to one.

The center server 30 is installed in, for example, a manufacturer that manufactures the vehicle 12 or a car dealer affiliated with the manufacturer. The terminal 40 is shown as an example of a smartphone or a personal computer owned by an owner and an administrator of the vehicle 12.

Vehicle

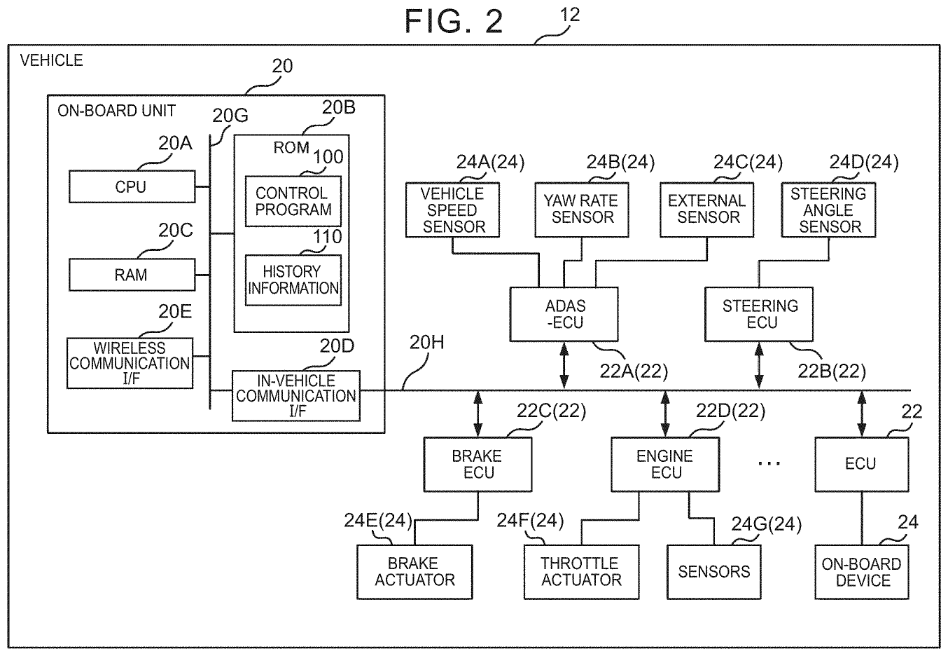

As shown in FIG. 2, the vehicle 12 according to the present embodiment includes the on-board unit 20, a plurality of electronic control units (ECUs) 22, and a plurality of on-board devices 24.

The on-board unit 20 includes a central processing unit (CPU) 20A, a read-only memory (ROM) 20B, a random access memory (RAM) 20C, an in-vehicle communication interface (I/F) 20D, and a wireless communication I/F 20E. The CPU 20A, the ROM 20B, the RAM 20C, the in-vehicle communication I/F 20D, and the wireless communication I/F 20E are connected so as to be able to communicate with each other via an internal bus 20G.

The CPU 20A is a central processing unit that executes various programs and controls various units. That is, the CPU 20A reads the program from the ROM 20B and executes the program using the RAM 20C as a work area.

The ROM 20B stores various programs and various data. The ROM 20B according to the present embodiment stores a control program 100 that collects vehicle information related to the state and control of the vehicle 12 from the ECUs 22, and permits or restricts the use of the function of the vehicle 12 or the application of the equipment to the vehicle 12. Along with the execution of the control program 100, the on-board unit 20 executes each process including the setting process described below. Further, the ROM 20B stores history information 110 that is backup data of the vehicle information. The RAM 20C temporarily stores a program or data as a work area.

The in-vehicle communication I/F 20D is an interface for connecting to each of the ECUs 22. For the interface, a communication standard based on a controller area network (CAN) protocol is used. The in-vehicle communication I/F 20D is connected to an external bus 20H.

The wireless communication I/F 20E is a wireless communication module for communicating with the center server 30. For the wireless communication module, for example, communication standards such as fifth generation (5G), long term evolution (LTE), and Wi-Fi (registered trademark) are used. The wireless communication I/F 20E is connected to the network N.

The ECUs 22 include at least an advanced driver assistance system (ADAS)—ECU 22A, a steering ECU 22B, a brake ECU 22C, and an engine ECU 22D.

The ADAS-ECU 22A controls an advanced driver assistance system in an integrated manner. A vehicle speed sensor 24A, a yaw rate sensor 24B, and an external sensor 24C that constitute the on-board devices 24 are connected to the ADAS-ECU 22A. The external sensor 24C is a group of sensors used for detecting the surrounding environment of the vehicle 12. The external sensor 24C includes, for example, a camera that captures images of surrounding areas of the vehicle 12, a millimeter-wave radar that transmits an exploration wave and receives a reflective wave, a laser imaging detection and ranging (LiDAR) that scans a front area of the vehicle 12, and the like.

The steering ECU 22B controls power steering. A steering angle sensor 24D constituting the on-board devices 24 is connected to the steering ECU 22B. The steering angle sensor 24D is a sensor that detects the steering angle of the steering wheel.

The brake ECU 22C controls a brake system of the vehicle 12. A brake actuator 24E constituting the on-board devices 24 is connected to the brake ECU 22C.

The engine ECU 22D controls an engine of the vehicle 12. A throttle actuator 24F and sensors 24G constituting the on-board devices 24 are connected to the engine ECU 22D. The sensors 24G include an oil temperature sensor for measuring the oil temperature of engine oil, an oil pressure sensor for measuring the oil pressure of the engine oil, and a rotation sensor for detecting a rotation speed of the engine.

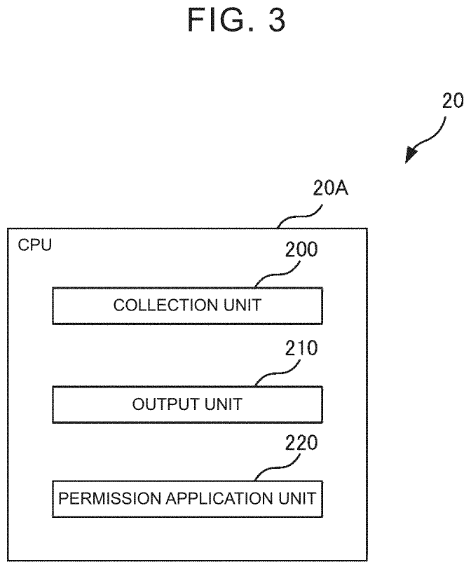

As shown in FIG. 3, in the on-board unit 20 according to the present embodiment, the CPU 20A functions as a collection unit 200, an output unit 210, and a permission application unit 220 by executing the control program 100.

The collection unit 200 has a function of acquiring vehicle information related to the state of the on-board device 24 from each ECU 22 of the vehicle 12 and the state of the vehicle 12 obtained from the on-board device 24. The vehicle information includes information on a vehicle speed, acceleration, yaw rate, steering angle, an accelerator operation amount, brake pedal depression force, stroke or the like. Further, the vehicle information may include an image of an area outside the vehicle 12 captured by the camera as the external sensor 24C.

The output unit 210 has a function of outputting the vehicle information collected by the collection unit 200 to the center server 30.

The permission application unit 220 has a function of executing permission or restriction of the use of the function of the vehicle 12 and permission or restriction of the application of the equipment to the vehicle 12 based on the permission information acquired from the center server 30. Examples of the function of the vehicle 12 include functions controlled by the ECU 22 such as an engine output mode and an advanced driver assistance system. Examples of the equipment of the vehicle 12 include functions that can be monitored by the ECU 22 such as an exterior option, color scheme, and the like of the vehicle 12.

Center Server

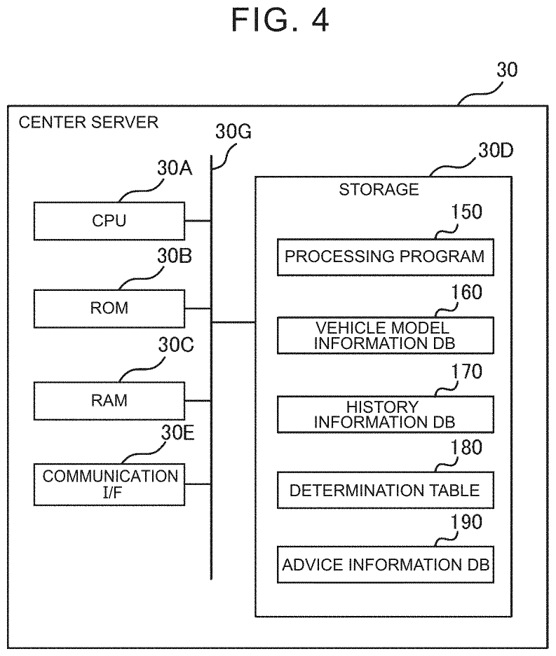

As shown in FIG. 4, the center server 30 includes a CPU 30A, a ROM 30B, a RAM 30C, a storage 30D, and a communication I/F 30E. The CPU 30A, the ROM 30B, the RAM 30C, the storage 30D, and the communication I/F 30E are connected so as to be able to communicate with each other via an internal bus 30G. The functions of the CPU 30A, the ROM 30B, the RAM 30C and the communication I/F 30E are the same as those of the CPU 20A, the ROM 20B, the RAM 20C and the wireless communication I/F 20E of the on-board unit 20 described above. The communication I/F 30E may perform wired communication.

The storage 30D as a memory is composed of a hard disk drive (HDD) or a solid state drive (SSD), and stores various programs and various data. The storage 30D according to the present embodiment stores a processing program 150, a vehicle model information database (DB) 160, a history information DB 170, a determination table 180, and an advice information DB 190. The ROM 30B may store the processing program 150, the vehicle model information DB 160, the history information DB 170, the determination table 180, and the advice information DB 190.

The processing program 150 as a program is a program for controlling the center server 30. Along with the execution of the processing program 150, the center server 30 executes each process including a determination process for determining the driving skill of the driver of the vehicle 12.

The vehicle model information DB 160 is a database in which information on functions, equipment, specifications, and the like for each vehicle model is stored. The history information DB 170 stores the history of the determination result of each driver registered in the center server 30.

The determination table 180 stores information to be referred to when the rank of the driving skill of the driver is determined.

In the advice information DB 190, advice information related to the advice from a driver having a highly ranked driving skill is stored for each driving mode. The advice information is information for encouraging the driver to improve the driving skill, such as an advice on driving operations and attitude for safe driving. The advice information may be in any form of voice information, text information, and image information.

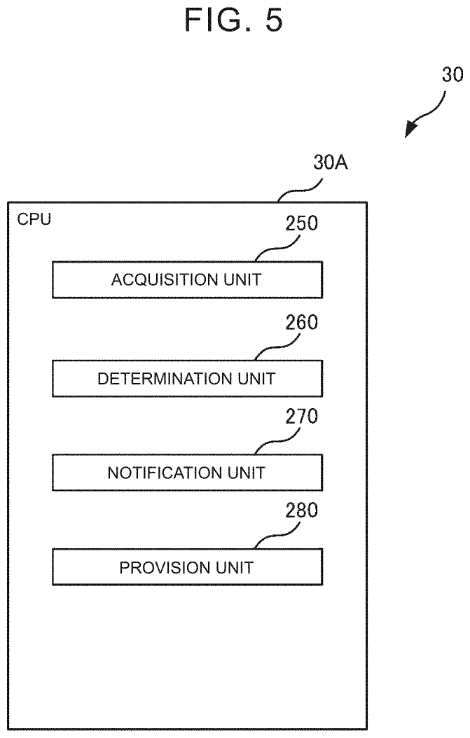

As shown in FIG. 5, in the center server 30 according to the present embodiment, the CPU 30A functions as an acquisition unit 250, a determination unit 260, a notification unit 270, and a provision unit 280 by executing the processing program 150.

The acquisition unit 250 has a function of acquiring the vehicle information of the vehicle 12 from the on-board unit 20 of the vehicle 12. The acquisition unit 250 acquires the vehicle information transmitted from the on-board unit 20 at any timing.

The determination unit 260 has a function of determining the driving skill of the driver of the vehicle 12 related to the vehicle information based on the vehicle information acquired by the acquisition unit 250. Specifically, the determination unit 260 ranks a driver according to driving modes such as acceleration and deceleration of the vehicle 12, a steering operation of the vehicle 12, an inter-vehicle distance from other vehicles to the vehicle 12, and a distance from pedestrians to the vehicle 12.

The notification unit 270 has a function of notifying the user of the vehicle 12 of permission information. Specifically, the notification unit 270 generates the permission information for permitting the use of the function of the vehicle 12 or the application of the equipment to the vehicle 12 according to the driving skill determined by the determination unit 260. For example, when the skill in the driving mode related to the acceleration and deceleration, and the steering operations is high, the notification unit 270 generates permission information for permitting the use of the sports mode function having a high engine output. Further, for example, when the skill in the driving mode related to the inter-vehicle distance is low, the notification unit 270 generates permission information for restricting the cancellation of the advanced driver assistance system. Further, for example, when the skill in the driving mode related to the accelerator operation is high, the notification unit 270 generates permission information for permitting the application of the predetermined exterior parts. Further, for example, when the skill in the driving mode related to the brake operation is low, the notification unit 270 generates permission information for restricting the application of the predetermined interior options.

Then, the notification unit 270 transmits the generated permission information to the on-board unit 20. The permission information according to this embodiment includes information on date and time at which the permission information is generated.

The provision unit 280 has a function of notifying the on-board unit 20 of the vehicle 12 of the advice information. Specifically, the provision unit 280 selects an advice corresponding to the driving skill and the driving mode of the driver from the advice information DB 190, and provides the advice to the on-board unit 20.

Flow of Control

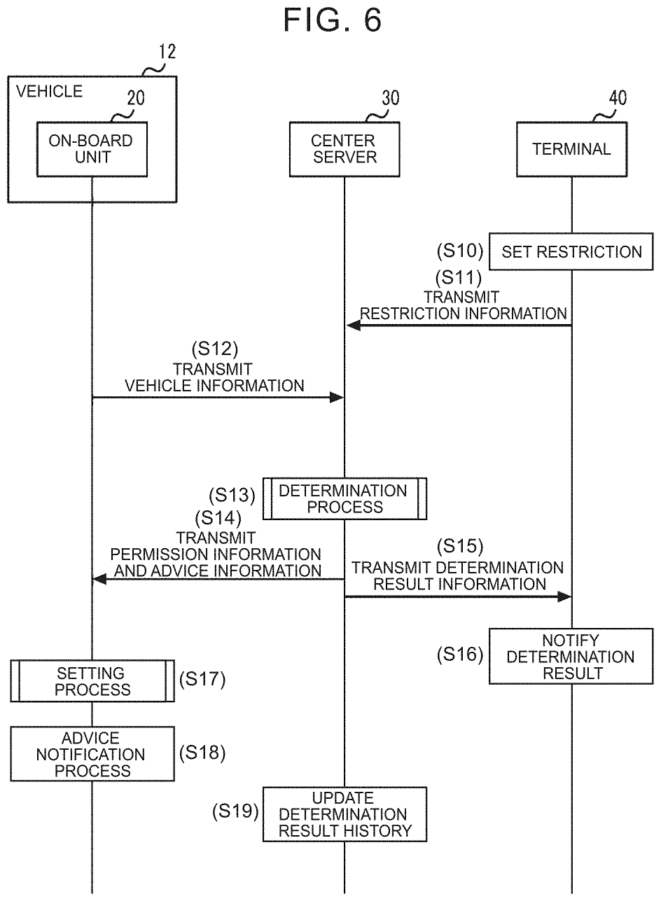

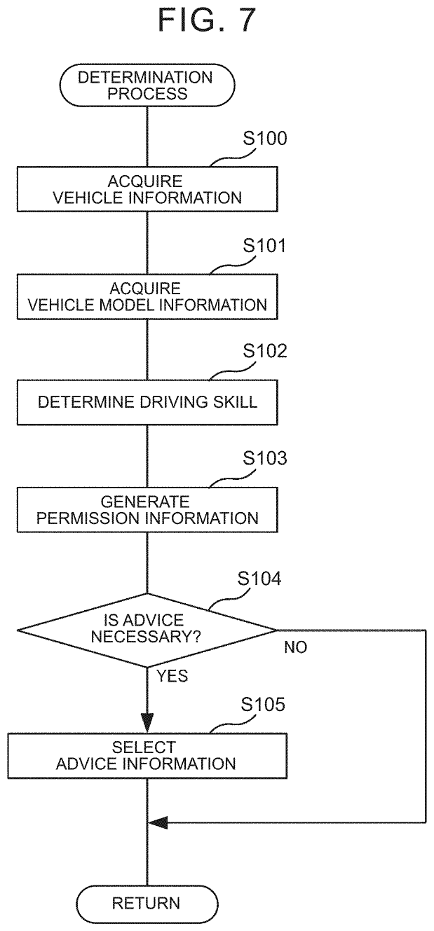

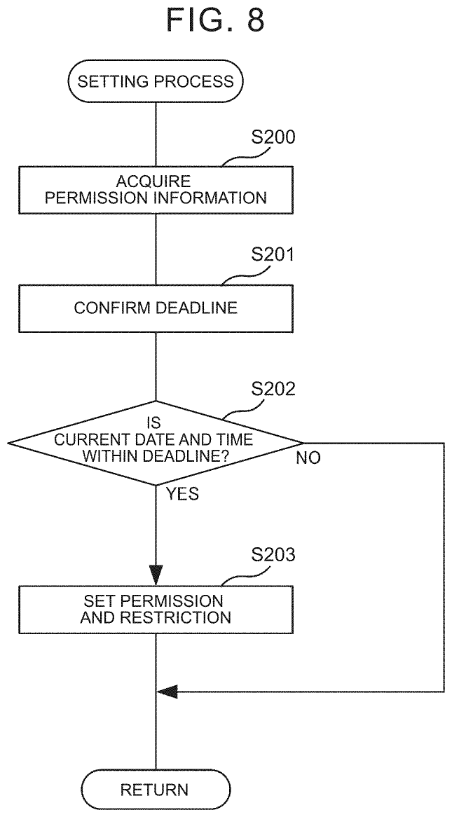

The flow of processing as a control method executed by the vehicle control system 10 according to the present embodiment will be described with reference to the sequence diagram of FIG. 6 and the flowcharts of FIGS. 7 and 8. The process in the on-board unit 20 is executed by the CPU 20A of the on-board unit 20 functioning as the collection unit 200, the output unit 210, and the permission application unit 220. Further, the process in the center server 30 is executed by the CPU 30A of the center server 30 functioning as the acquisition unit 250, the determination unit 260, the notification unit 270, and the provision unit 280.

In step S10 of FIG. 6, the restriction setting is executed on the terminal 40 of the administrator or the owner. For example, through the touch panel of the terminal 40 that is a smartphone, the administrator or the owner can make settings related to the restriction of the use of the power mode in which the acceleration performance is improved.

In step S11, the terminal 40 transmits, to the center server 30, restriction information on the function of which the use is restricted or the equipment of which the application is restricted. The processes in steps S10 and S11 are not essential processes, and a process may be started from step S12.

In step S12, in the on-board unit 20, the CPU 20A transmits vehicle information to the center server 30. The vehicle information is transmitted at any timing, such as when an ignition in the vehicle 12 is turned ON or OFF, or when a command requesting transmission of the vehicle information is received from the center server 30.

In step S13, in the center server 30, the CPU 30A executes the determination process. Details of the determination process will be described below. As a result of the determination process, permission information and, as necessary, advice information are generated.

In step S14, in the center server 30, the CPU 30A transmits the permission information and the advice information to the on-board unit 20.

In step S15, in the center server 30, the CPU 30A transmits, to the terminal 40, determination result information in the determination process.

In step S16, the terminal 40 that has received the determination result information notifies the user of the determination result.

In step S17, in the on-board unit 20 that has received the permission information, the CPU 20A executes the setting process. Details of the setting process will be described below.

In step S18, in the on-board unit 20 that has received the advice information, the CPU 20A executes an advice notification process. Specifically, the CPU 20A notifies the user of the content of the advice information, that is, the content of the advice from a driver having a highly ranked driving skill through a display device such as a monitor or a center display of a car navigation device connected to the on-board unit 20, and a speaker.

In step S19, in the center server 30, the CPU 30A updates the history of the determination result. That is, the CPU 30A updates the history information DB 170 based on the determination result of this time.

Next, details of the determination process in step S13 will be described. In step S100 of FIG. 7, the CPU 30A acquires the vehicle information.

In step S101, the CPU 30A acquires vehicle model information. Specifically, the CPU 30A acquires information on functions, equipment, specifications, and the like of the vehicle 12 from the vehicle model information DB 160.

In step S102, the CPU 30A executes the driving skill determination. Specifically, the CPU 30A makes a correction for each vehicle model to the vehicle information, and then determines the driving skill of the driver based on the determination table 180.

In step S103, the CPU 30A generates the permission information. Specifically, the CPU 30A generates information related to permission or restriction of the use of the function of the vehicle 12 and provision of the equipment to the vehicle 12 based on the rank of the driving skill for each driving mode.

In step S104, the CPU 30A determines whether the advice is necessary. Specifically, the CPU 30A determines that the advice is necessary when there is a driving mode in which the rank of the driving skill is equal to or lower than a preset rank. When the CPU 30A determines that the advice is necessary (YES in step S104), the CPU 30A proceeds to step S105. On the other hand, when the CPU 30A determines that the advice is not necessary (NO in step S104), the CPU 30A ends the determination process.

In step S105, the CPU 30A selects advice information. That is, the CPU 30A selects the corresponding advice information from the advice information DB 190 for the driving mode in which the rank of the driving skill is equal to or lower than the preset rank. Then, the CPU 30A ends the determination process.

Next, details of the setting process in step S17 will be described. In step S200 of FIG. 8, the CPU 20A acquires the permission information.

In step S201, the CPU 20A confirms the deadline included in the permission information.

In step S202, the CPU 20A determines whether information on the current date and time in the permission information is within the deadline. When the CPU 20A determines that the current date and time is within the deadline (YES in step S202), the CPU 20A proceeds to step S203. On the other hand, when the CPU 20A determines that the current date and time is not within the deadline, that is, the deadline has expired (NO in step S202), the CPU 20A ends the setting process.

In step S203, the CPU 20A executes a permission and restriction setting. Specifically, the CPU 20A executes settings for permitting a function and equipment to be permitted, and settings for restricting a function and equipment to be restricted. Then, each setting is reflected in each ECU 22. As a result, the function permitted to be used is executed in the vehicle 12, and the equipment permitted to be applied is accepted by the vehicle 12. On the other hand, the function of which the use is restricted is not executed in the vehicle 12, and the equipment of which the application is restricted is not accepted by the vehicle 12, and even when such equipment can be physically installed, the equipment cannot be used. Then, the CPU 20A ends the setting process.

### SUMMARY

The center server 30 as the control device according to the present embodiment determines the driving skill of the driver of the vehicle 12 based on the vehicle information acquired from the vehicle 12. Then, when the determined driving skill is high, the center server 30 permits the use of the function of the vehicle 12 or the application of the equipment to the vehicle 12, and when the determined driving skill is low, the center server 30 restricts the use of the function of the vehicle 12 or the application of the equipment to the vehicle 12. Therefore, when the driver wishes to use the function of the vehicle 12 or apply the equipment to the vehicle 12, the driver endeavors to improve the driving skill. That is, according to the present embodiment, it is possible to encourage the driver to improve the driving skill by permitting or restricting the use of the function of the vehicle 12 or the application of the equipment to the vehicle 12 according to the driving skill of the driver.

Further, with the center server 30 according to the present embodiment, it is possible to encourage the driver to improve the driving skill by providing the advice from the driver having the higher driving skill to the driver determined to have the lower driving skill.

Further, with the center server 30 according to the present embodiment, the driving skill is determined based on the vehicle model information. That is, according to the present embodiment, the driving skill can be determined by excluding the influence of a difference in the vehicle model.

Further, with the vehicle control system 10 according to the present embodiment, when the time has passed after the reception of the determination of the driving skill, the reliability of the determination is guaranteed by invalidating the permission of the use of the function of the vehicle 12 or the application of the equipment to the vehicle 12.

Remarks

In the above embodiment, the center server 30 is used as the control device, but the present disclosure is not limited to this, and the on-board unit 20 may be used as the control device. In this case, the on-board unit 20 collects the vehicle information of the vehicle 12 on which the on-board unit 20 is mounted, executes a determination process, and executes a setting process.

It should be noted that various processors other than the CPU may execute the various processes that are executed when the CPU 20A and the CPU 30A read the software (program) in the above embodiment. Examples of the processors in this case include a programmable logic device (PLD) such as a field-programmable gate array (FPGA) for which a circuit configuration can be changed after production, a dedicated electric circuit that is a processor having a circuit configuration designed exclusively for executing a specific process, such as an application specific integrated circuit (ASIC), and the like. Further, each process described above may be executed by one of these various processors, or a combination of two or more processors of the same type or different types (for example, a combination of FPGAs, a combination of a CPU and an FPGA, and the like). Further, the hardware structure of each of the various processors is, more specifically, an electric circuit in which circuit elements such as semiconductor elements are combined.

Further, in the above embodiment, a mode in which each program is stored (installed) in a non-transitory computer-readable recording medium (storage medium) in advance is described. For example, the control program 100 in the on-board unit 20 is stored in advance in the ROM 20B, and the processing program 150 in the center server 30 is stored in advance in the storage 30D. However, the present disclosure is not limited to this, and the program may be recorded on a non-transitory recording medium such as a compact disc read-only memory (CD-ROM), a digital versatile disc read-only memory (DVD-ROM), and a universal serial bus (USB) memory to be provided. Further, the program may be downloaded from an external device via a network.

The flow of processing described in the above embodiment is an example, and unnecessary steps may be deleted, new steps may be added, or the process order may be changed within a range that does not deviate from the gist.

What is claimed is:

1. A control device comprising a processor configured to:
acquire vehicle information on a vehicle;
determine a driving skill of a driver from the acquired vehicle information; and
notify the driver of permission information for permitting use of a function of the vehicle or application of equipment to the vehicle according to the determined driving skill.

2. The control device according to claim 1, wherein the processor provides an advice from a driver having a higher driving skill.

3. The control device according to claim 1, wherein the processor determines the driving skill according to a model of the vehicle.

4. A vehicle control system comprising:
the control device according to claim 1; and
the vehicle of which the use of the function or to which the application of the equipment according to the permission information is permitted.

5. The vehicle control system according to claim 4, wherein:
the permission information has a set deadline in the vehicle; and
the vehicle prohibits permission of the use of the function or the application of the equipment by the permission information of which the set deadline has expired.

6. A control method in which a computer executes processes comprising:
acquiring vehicle information on a vehicle;
determining a driving skill of a driver from the acquired vehicle information; and
notifying the driver of permission information for permitting use of a function of the vehicle or application of equipment to the vehicle according to the determined driving skill.

7. A non-transitory storage medium storing a program that causes a computer to execute processes comprising:
acquiring vehicle information on a vehicle;
determining a driving skill of a driver from the acquired vehicle information; and
notifying the driver of permission information for permitting use of a function of the vehicle or application of equipment to the vehicle according to the determined driving skill.
